(19) United States
(12) Patent Application Publication
(10) Pub. No.: US 2018/0090734 A1
(43) Pub. Date: Mar. 29, 2018

(54) ENERGY STORAGE APPARATUS

(71) Applicant: GS Yuasa International Ltd., Kyoto-shi (JP)

(72) Inventors: Shogo TSURUTA, Kyoto-shi (JP); Yuichiro YAMAMOTO, Kyoto-shi (JP)

(21) Appl. No.: 15/699,788

(22) Filed: Sep. 8, 2017

(30) Foreign Application Priority Data
Sep. 27, 2016 (JP) 2016-188547

(51) Int. Cl. H01M 2/20; H01M 2/30; H01M 10/42; H01M 2/02; H01M 2/10

(52) U.S. Cl. CPC H01M 2/206; H01M 2/30; H01M 10/425; H01M 10/625; H01M 2/1077; H01M 2220/20; H01M 2200/106; H01M 2/0237

(57) ABSTRACT

An energy storage apparatus includes an energy storage device, a circuit board, a first outer case, and a metal bar which electrically connects an external conductive member and the circuit board to each other, the metal bar is integrally formed with the first outer case, and an end part of the metal bar which is exposed inward from the first outer case is inserted into a first connector of the circuit board.

### CROSS-REFERENCE TO RELATED APPLICATIONS

This application is based on Japanese Patent Application No. 2016-188547, filed on Sep. 27, 2016, the entire contents of which are hereby incorporated by reference.

### FIELD

The present invention relates to an energy storage apparatus which includes an energy storage device, a circuit board, and an outer case.

### BACKGROUND

Conventionally, there has been known an energy storage apparatus which includes an energy storage device, a printed circuit board, and an outer case (see JP 2016-33907 A, for example).

In such a conventional energy storage apparatus, the configuration for electrically connecting the printed circuit board to an external conductive member (external wiring or the like) may be complicated and an assembling operation of the apparatus may become complicated. In the conventional energy storage apparatus, to connect the circuit board accommodated in the outer case to the external conductive member, the configuration is adopted where one end of a cable is connected to the circuit board, the other end of the cable is made to pass through the outer case, and the cable and the external conductive member are connected to each other. Thus, the cable has to be properly arranged/handled and handling of the cable becomes cumbersome.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

An object of the present invention to provide an energy storage apparatus which can simplify the connection configuration.

According to an aspect of the present invention, there is provided an energy storage apparatus which includes an energy storage device, a circuit board, an outer case, and a metal bar which electrically connects an external conductive member and the circuit board to each other, wherein the metal bar is integrally formed with the outer case, and an end part of a portion which is exposed inward from the outer case is inserted into a connector of the circuit board.

### BRIEF DESCRIPTION OF DRAWINGS

The foregoing and other features of the present invention will become apparent from the following description and drawings of an illustrative embodiment of the invention in which:

FIG. 1 is a perspective view showing an external appearance of an energy storage apparatus according to an embodiment.

FIG. 2 is an exploded perspective view showing respective constitutional elements when the energy storage apparatus is in a disassembled state.

FIG. 3 is an exploded perspective view showing respective constitutional elements when an energy storage unit included in the energy storage apparatus are in a disassembled state.

FIG. 4A to FIG. 4C are perspective views showing a configuration of a first outer case, and a configuration where an external connector is integrally formed with the first outer case.

FIG. 5 is a perspective view showing a configuration of the external connector and a metal bar which are integrally formed with the first outer case.

FIG. 6 is a perspective view showing a configuration of a holding member and a printed circuited board according to the embodiment, and a configuration where an exposed end part of the metal bar is inserted into a first connector of the circuit board.

FIG. 7 is a perspective view showing a configuration of a second positioning portion of the holding member and a positional relationship between first positioning portions and the second positioning portion.

FIG. 8 is a perspective view showing a configuration where the first outer case is positioned with respect to the holding member, and the exposed end part of the metal bar is inserted into the first connector.

FIG. 9 is a plan view showing a configuration where the first outer case and the holding member are joined to each other.

FIG. 10 is a side view showing a configuration of a metal bar according to a modification 1 of the embodiment.

FIG. 11A is a cross-sectional view showing a configuration where a metal bar according to a modification 2 of the embodiment is integrally formed with the first outer case fixedly by adhesion.

FIG. 11B is a cross-sectional view showing a configuration where the metal bar according to the modification 2 is integrally formed with the first outer case fixedly by fastening.

### DESCRIPTION OF EMBODIMENTS

According to an aspect of the present invention, there is provided an energy storage apparatus which includes an energy storage device, a circuit board, an outer case, and a metal bar which electrically connects an external conductive member and the circuit board to each other, wherein the metal bar is integrally formed with the outer case, and an end part of a portion which is exposed inward from the outer case is inserted into a connector of the circuit board.

With such a configuration, the energy storage apparatus includes the metal bar which connects the external conductive member and the circuit board to each other, the metal bar is integrally formed with the outer case, and the end part of the exposed portion is inserted into the connector of the circuit board. That is, the energy storage apparatus is configured such that the metal bar can be easily inserted into the connector by inserting the metal bar integrally formed with the outer case into the connector. According to the energy storage apparatus, the connecting configuration between the cable and the circuit board which has been adopted conventionally can be simplified.

The metal bar may have a bent part which is bent or curved.

With such a configuration, the metal bar has the bent part and hence, the adjustment of a position where the metal bar is inserted into the connector can be easily performed whereby the metal bar can be easily inserted into the connector.

At least a portion of the bent part may be integrally formed with the outer case.

With such a configuration, the bent part of the metal bar is integrally formed with the outer case and hence, the metal bar can be stably fixed in the outer case whereby the metal bar can be stably disposed.

The metal bar may have a plurality of such bent parts in a middle of a portion of the metal bar extending toward the connector.

With such a configuration, the plurality of bent parts are formed on the portion of the metal bar extending toward the connector and hence, a movable range of the end part of the metal bar is expanded. Accordingly, the adjustment of the position where metal bar is inserted into the connector can be performed more easily whereby the metal bar can be more easily inserted into the connector.

A portion of the connector into which the metal bar is fitted may be formed movably relative to the circuit board along a surface of the circuit board.

With such a configuration, the portion of the connector into which the metal bar is fitted moves along the surface of the circuit board and hence, the metal bar can be easily fitted into the connector. Accordingly, the metal bar can be easily inserted into the connector.

The energy storage apparatus may further include a holding member for holding the circuit board, and at least one of the outer case and the holding member may have a positioning portion which engages with the other of the outer case and the holding member and positions the outer case with respect to the holding member.

With such a configuration, the positioning portion positions the outer case with respect to the holding member of the circuit board and hence, the metal bar integrally formed with the outer case can be easily positioned with respect to the connector of the circuit board. Accordingly, the metal bar can be easily inserted into the connector.

The outer case may include the positioning portion which is formed on the outer case in a projecting manner toward the holding member, and may guide the end part of the metal bar to the connector.

With such a configuration, the positioning portion formed on the outer case in a projecting manner toward the holding member guides the end part of the metal bar to the connector and hence, the metal bar can be easily inserted into the connector.

The outer case and the holding member may have a joint portion formed by joining the outer case and the holding member to each other.

With such a configuration, the outer case and the holding member are joined to each other and hence, it is possible to suppress the displacement of the metal bar from the connector.

The joint portion may be disposed around the positioning portion.

With such a configuration, the outer case and the holding member are joined to each other around the positioning portion and hence, joint between the outer case and the holding member can be strengthened whereby it is possible to more effectively suppress the displacement of the metal bar from the connector.

The metal bar may be formed into a shape where the end part of the metal bar is tapered toward the connector.

With such a configuration, the end part of the metal bar is tapered and hence, the metal bar can be easily inserted into the connector.

According to another aspect of the present invention, there is provided a method of manufacturing an energy storage apparatus which includes an energy storage device, a circuit board, and an outer case, wherein the method includes: a positioning step where an end part of a portion of a metal bar integrally formed with the outer case exposed inward from the outer case is made to overlap with a connector of the circuit board as viewed in a direction from the outer case toward the circuit board; and an insertion step where the end part is inserted into the connector.

With such a configuration, in the method of manufacturing an energy storage apparatus, in a state where the end part of the exposed portion of the metal bar integrally formed with the outer case is made to overlap with the connector of the circuit board as viewed in the direction from the outer case to the circuit board, the end part is inserted into the connector. That is, in the method of manufacturing an energy storage apparatus, the metal bar can be easily inserted into the connector by inserting the metal bar integrally formed with the outer case into the connector. According to the method of manufacturing an energy storage apparatus, the connecting configuration between the cable and the circuit board which has been adopted conventionally can be simplified.

In the positioning step, the end part of the metal bar may be made to overlap with the connector by positioning the outer case with respect to the circuit board.

With such a configuration, the end part of the metal bar can be made to overlap with the connector by positioning the outer case with respect to the circuit board. That is, the metal bar can be inserted into the connector by positioning the outer case with respect to the circuit board and, thereafter, by bringing the outer case close to the circuit board. In this manner, the metal bar can be easily inserted into the connector.

The present invention can be realized not only in the form of an energy storage apparatus but also in the form of an outer case, a metal bar, a connector of a circuit board or a holding member of the circuit board which the energy storage apparatus includes.

According to the energy storage apparatus, the connecting configuration between the cable and the circuit board which has been adopted conventionally can be simplified.

Hereinafter, an energy storage apparatus according to an embodiment of the present invention is described with reference to drawings. The embodiment described hereinafter is a comprehensive or specific example of the present invention. In the embodiment described hereinafter, numerical values, shapes, materials, constitutional elements, the arrangement positions and connection states of the constitutional elements, the manufacturing step, the order of manufacturing steps and the like are merely examples, and these are not intended to be used for limiting the present invention. Further, out of the constitutional elements in the embodiment described hereinafter, the constitutional elements which are not described in independent claims describing an uppermost concept of the present invention are described as arbitrary constitutional elements. In the respective drawings, the respective constitutional elements are not always described strictly accurate in size or the like.

In the following description and drawings, an arrangement direction of the energy storage devices, an arrangement direction of spacers, an arrangement direction of sandwiching members, a direction that long-side surfaces of the container of the energy storage device opposedly face each other or a thickness direction of the container is defined as an X axis direction. An arrangement direction of the electrode terminals in one energy storage device or a direction that short-side surfaces of the container of the energy storage device opposedly face each other is defined as a Y axis direction. A vertical direction of the energy storage device (a direction that gravity acts on the energy storage device in a state where a lid of the container is directed upward) is defined as a Z axis direction. These X axis direction, Y axis direction and Z axis direction are directions intersecting with each other (orthogonal to each other in this embodiment). There may be also a case where the Z axis direction is not the vertical direction depending on a mode of use. However, hereinafter, for the sake of convenience of description, the description is made using the Z axis direction as the vertical direction. In the description made hereinafter, for example, a plus side in the X axis direction indicates an arrow direction side in an X axis, and a minus side in the X axis direction indicates a side opposite to the plus side in the X axis direction. The same goes for the Y axis direction and the Z axis direction.

### EMBODIMENT

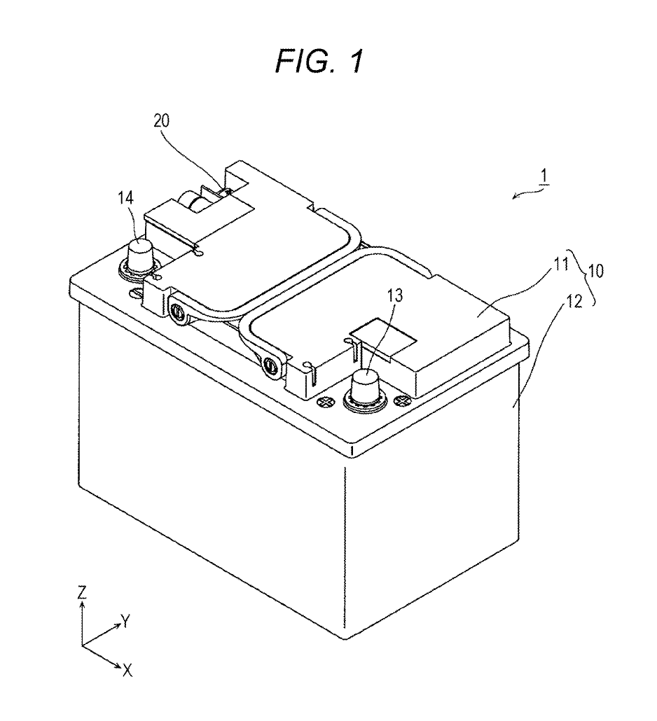

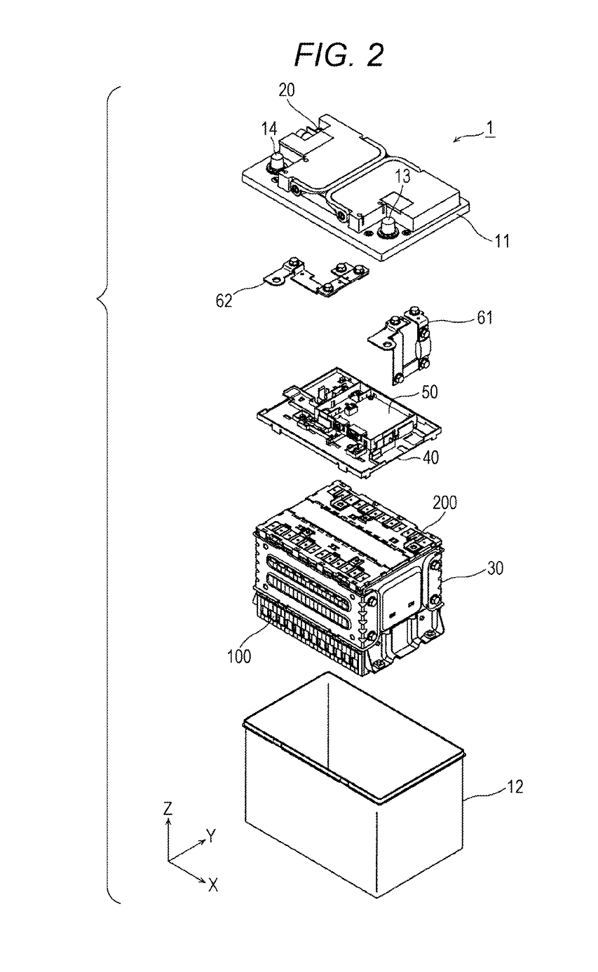

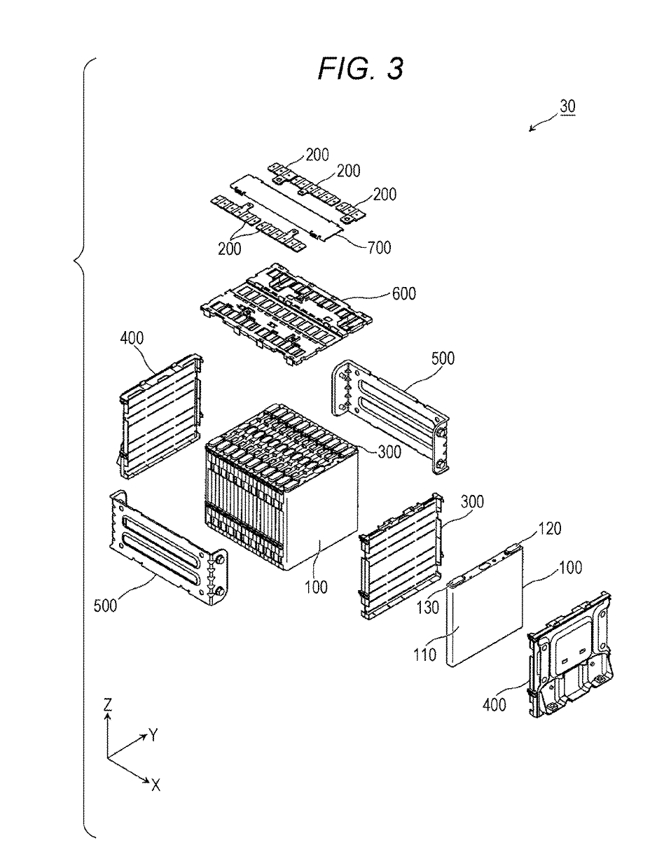

Firstly, an entire configuration of an energy storage apparatus 1 is described. FIG. 1 is a perspective view showing an external appearance of the energy storage apparatus 1 according to this embodiment. FIG. 2 is an exploded perspective view showing respective constitutional elements when the energy storage apparatus 1 according to this embodiment is in a disassembled state. FIG. 3 is an exploded perspective view showing the respective constitutional elements when an energy storage unit 30 included in the energy storage apparatus 1 according to this embodiment is in a disassembled state.

The energy storage apparatus 1 is an apparatus which can be charged with electricity from the outside and can discharge electricity to the outside. For example, the energy storage apparatus 1 is a battery module which is used for power storage application, power source application or the like. More specifically, the energy storage apparatus 1 is used as an engine starting battery of an automobile such as an electric vehicle (EV), a hybrid electric vehicle (HEV) or a plug-in hybrid electric vehicle (PHEV), or a movable body such as a motorcycle, a watercraft, a snowmobile, an agricultural machine, and a construction machine, for example.

As shown in FIG. 1 and FIG. 2, the energy storage apparatus 1 includes an outer case 10 formed of a first outer case 11 and a second outer case 12, and an energy storage unit 30, a holding member 40, a printed circuit board 50, bus bars 61, 62 and the like which are accommodated in the inside of the outer case 10.

The outer case 10 is a rectangular-shaped (box-shaped) container (module case) which forms an outer case of the energy storage apparatus 1. That is, the outer case 10 is disposed outward the energy storage unit 30, the holding member 40, the printed circuit board 50, the bus bars 61, 62 and the like, and these energy storage unit 30 and the like are disposed at predetermined positions in the outer case 10 and hence, the outer case 10 protects the energy storage unit 30 and the like from an impact or the like. For example, the outer case 10 is made of an insulating material such as polycarbonate (PC), polypropylene (PP), polyethylene (PE), a polyphenylene sulfide resin (PPS), polybutylene terephthalate (PBT) or an ABS resin. With such a configuration, the outer case 10 prevents the energy storage unit 30 and the like from coming into contact with a metal member or the like disposed outside the outer case 10.

In this embodiment, the outer case 10 includes the first outer case 11 which forms a lid body of the outer case 10, and the second outer case 12 which forms a body of the outer case 10. The first outer case 11 is a flat rectangular-shaped cover member which closes an opening of the second outer case 12, and a positive electrode external terminal 13 and a negative electrode external terminal 14 are mounted on the first outer case 11. The energy storage apparatus 1 is charged with electricity therein from the outside of the energy storage apparatus 1 and discharges electricity to the outside of the energy storage apparatus 1 through the positive electrode external terminal 13 and the negative electrode external terminal 14. The second outer case 12 is a housing having a bottomed rectangular cylindrical shape in which an opening is formed, and accommodates the energy storage unit 30, the holding member 40, the bus bars 61, 62 and the like therein. The first outer case 11 and the second outer case 12 may be made of the same material, or may be made of different materials.

An external connector 20 which is connected to an external conductive member (external wiring or the like) is provided to the first outer case 11. The external connector 20 is a connector for electrically connecting the external conductive member to the printed circuit board 50, and is integrally formed with the first outer case 11 by insert molding or the like. The configuration of the first outer case 11, and the configuration where the external connector 20 is integrally formed with the first outer case 11 are described in detail later.

The energy storage unit 30 includes a plurality of energy storage devices 100 and a plurality of bus bars 200, and is electrically connected to the positive electrode external terminal 13 and the negative electrode external terminal 14 provided to the first outer case 11 through the bus bars 61, 62 respectively. In this embodiment, as shown in FIG. 3, the energy storage unit 30 further includes a plurality of spacers 300, a pair of sandwiching members 400, a plurality of binding members 500, a bus bar frame 600, and a heat shielding plate 700.

The energy storage device 100 is a secondary battery (battery cell) which can be charged with or discharge electricity. More specifically, the energy storage device 100 is a nonaqueous electrolyte secondary battery such as a lithium ion secondary battery. The energy storage devices 100 respectively have a flat rectangular shape, and are arranged in a row in the X axis direction such that the energy storage device 100 and the spacer 300 are alternately arranged. The spacer 300 is made of an insulating material such as PC, PP, PE, PPS, PBT or an ABS resin, for example, and is a plate-like member which provides insulation between two energy storage devices 100. The energy storage device 100 includes a metal-made container 110, and electrode terminals (positive electrode terminal 120 and negative electrode terminal 130). In the inside of the container 110, an electrode assembly, current collectors and the like are disposed, and an electrolyte solution (nonaqueous electrolyte) or the like is sealed. However, the detailed description of such a configuration is omitted. The energy storage device 100 is not limited to the nonaqueous electrolyte secondary battery, and may be a secondary battery other than the nonaqueous electrolyte secondary battery or may be a capacitor. Further, the energy storage device 100 may be a primary battery which can use stored electricity without being charged by a user.

The bus bars 200 are conductive members which are electrically connected to the respective electrode terminals which the plurality of energy storage devices 100 include, and are made of copper, a copper alloy, aluminum, an aluminum alloy or the like, for example. The sandwiching members 400 are flat-plate-like members (end plates) disposed on both sides of a unit constituted of the plurality of energy storage devices 100 in the X axis direction, and are members made of metal such as steel or stainless steel, for example, from a viewpoint of strength and the like. The binding members 500 are elongated flat-plate-like members (bonding bars) which have both ends thereof mounted on the sandwiching members 400 respectively thus binding the plurality of energy storage devices 100, and are formed of metal members such as steel or stainless steel, for example, similarly to the sandwiching members 400. The bus bar frame 600 is a member which can provide insulation between the bus bars 200 and other members, can regulate positions of the bus bars 200, and is made of an insulating material such as PC, PP, PE, PPS, PBT, an ABS resin or the like, for example. The heat shielding plate 700 is a plate-like member having insulating property which is disposed in a flow passage for a gas discharged from gas release valves of the energy storage devices 100.

Returning to FIG. 2, the holding member 40 is an electric equipment tray which can hold electric equipment such as the printed circuit board 50, the bus bars 61, 62, and other relays, and wirings (not shown) thereon, provides insulation between the printed circuit board 50, the bus bars 61, 62 and the like and other members, and restricts the positions of the printed circuit board 50, the bus bars 61, 62 and the like. The holding member 40 is made of an insulating material such as PC, PP, PE, PPS, PBT, an ABS resin or the like, for example.

More specifically, the holding member 40 is placed on an upper side (a plus side in the Z axis direction) of the energy storage unit 30, and is positioned with respect to the energy storage unit 30. The printed circuit board 50, the bus bars 61, 62 and the like are placed on the holding member 40, and are positioned with respect to the holding member 40. The first outer case 11 is disposed and positioned on the holding member 40. The configuration of the holding member 40, and the configuration where the first outer case 11 is positioned with respect to the holding member 40 are described in detail later.

The printed circuit board 50 is a control printed circuit board which is placed on the holding member 40, and is connected to the plurality of energy storage devices 100 in the energy storage unit 30 by wirings or the like. The printed circuit board 50 acquires, monitors, and controls states of the plurality of energy storage devices 100. More specifically, a control circuit (not shown) is mounted on the printed circuit board 50, and the control circuit acquires various kinds of information such as charging states and discharging states, voltage values, current values, and temperatures of the plurality of energy storage devices 100, controls ON and OFF of relays, and performs communication with other equipment. The configuration of the printed circuit board 50 is described in detail later.

The bus bars 61, 62 are conductive members placed on the holding member 40, and the bus bars 200 in the energy storage unit 30 and the positive electrode external terminal 13 and the negative electrode external terminal 14 mounted on the first outer case 11 are respectively electrically connected to each other through the bus bars 61, 62. The bus bars 61, 62 are made of copper, a copper alloy, aluminum, an aluminum alloy or the like, for example.

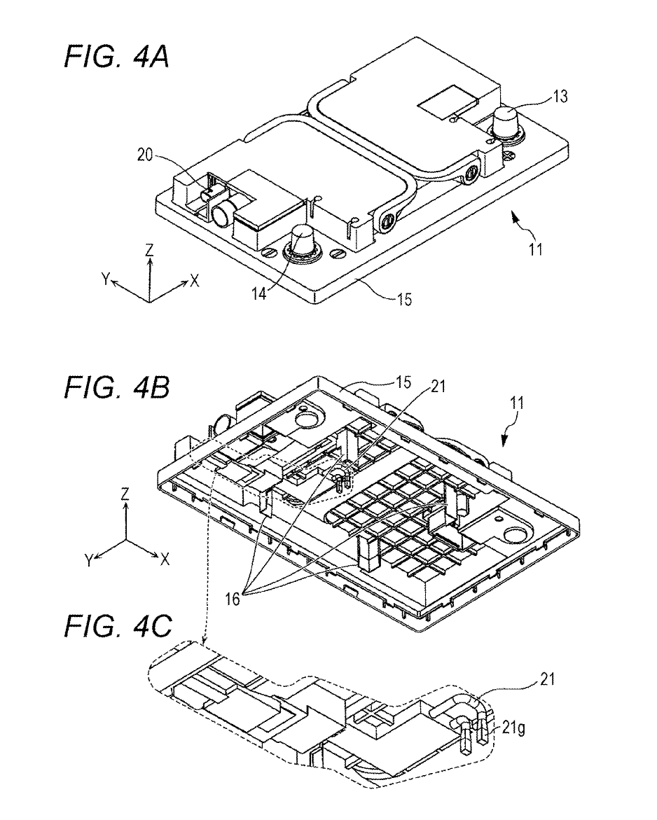

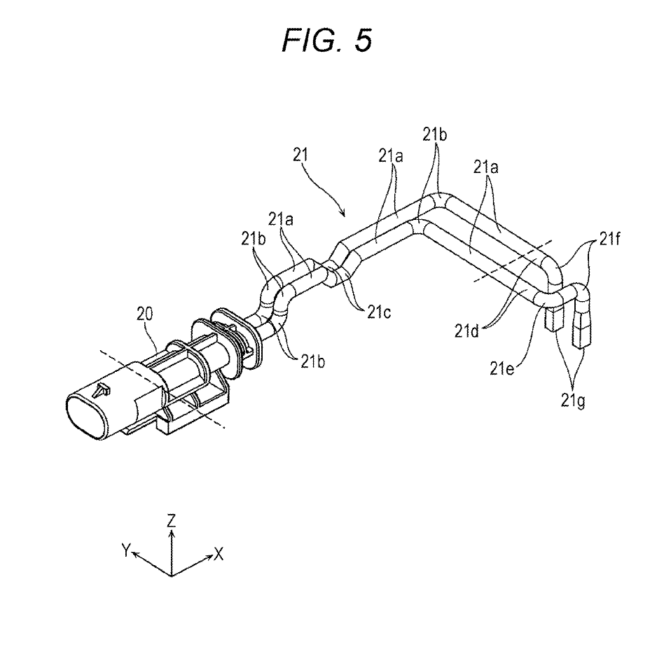

Next, the configuration of the first outer case 11 and the configuration where the external connector 20 is integrally formed with the first outer case 11 are described in detail. FIG. 4A to FIG. 4C are perspective views showing the configuration of the first outer case 11 according to this embodiment and the configuration where the external connector 20 is integrally formed with the first outer case 11. More specifically, FIG. 4A is a perspective view of the first outer case 11 shown in FIG. 2 as viewed from a left upper side, and FIG. 4B is a perspective view of the first outer case 11 as viewed from a left lower side. Further, FIG. 4C is a perspective view showing a portion of the first outer case 11 where the external connector 20 and the metal bar 21 are embedded in FIG. 4B in an enlarged manner. FIG. 5 is a perspective view showing a configuration of the external connector 20 and the metal bar 21 which are integrally formed with the first outer case 11 according to this embodiment.

As shown in these drawings, the first outer case 11 includes a flat rectangular-shaped first outer case body portion 15 which forms a body portion of the first outer case 11, and the external connector 20 and the metal bar 21 are embedded in the first outer case body portion 15 so that the external connector 20 and the metal bar 21 are integrally formed with the first outer case body portion 15. Hereinafter, the external connector 20 and the metal bar 21 are described in detail.

The external connector 20 is a member extending in the X axis direction and having an approximately circular cylindrical shape. The external connector 20 is disposed such that an approximately half of the external connector 20 on a minus side in the X axis direction is exposed from the first outer case body portion 15, and an approximately half of the external connector 20 on a plus side in the X axis direction is embedded in the first outer case body portion 15. The external connector 20 is made of an insulating material such as PC, PP, PE, PPS, PBT, or an ABS resin, for example, similarly to the holding member 40. The metal bar 21 is connected to the external connector 20 on a plus side in the X axis direction.

The metal bar 21 is a metal-made rod-like member which is inserted into the external connector 20 from a plus side in the X axis direction and is connected (fixed) to the external connector 20. The metal bar 21 is disposed in an embedded manner in the first outer case body portion 15 in a state where an end part of the metal bar 21 on a side opposite to the external connector 20 is exposed. With such a configuration, an external conductive member (an external wiring or the like) is connected to the external connector 20 so that the external conductive member is connected to the metal bar 21. The metal bar 21 is a conductive wire made of a conductive material such as copper, a copper alloy, aluminum or an aluminum alloy and having a diameter of approximately 0.1 to 0.5 mm, for example. That is, the metal bar 21 is a flexible member having rigidity and flexibility, and is flexibly deformable even when vibration, impact or the like is generated in the metal bar 21.

Specifically, in a state where the metal bar 21 is embedded in the first outer case body portion 15, the metal bar 21 projects toward a plus side in the X axis direction from the external connector 20, extends toward a plus side in the X axis direction while being bent or curved plural times and, thereafter, is bent toward a minus side in the Y axis direction and further extends toward the minus side in the Y axis direction, is exposed from the first outer case body portion 15 and, thereafter, is bent toward a minus side in the Z axis direction. More specifically, as shown in FIG. 5, the metal bar 21 has embedded straight parts 21a, embedded bent parts 21b, 21c, exposed straight parts 21d, an exposed bent part 21e, an exposed bent part 21f, and an exposed end part 21g. Although FIG. 5 shows the configuration where two metal bars 21 extend parallel to each other, the number of metal bars 21 is not limited to two, and the number of metal bars 21 may be one or three or more.

The embedded straight parts 21a are straight-shaped (circular columnar-shaped) parts which are embedded in the first outer case body portion 15, and extend in the X axis direction and in the Y axis direction respectively. The embedded bent parts 21b are curve-shaped (arc-shaped) parts embedded in the first outer case body portion 15, and are connected to the embedded straight parts 21a respectively. The embedded bent parts 21c are bent-shaped parts embedded in the first outer case body portion 15, and are connected to the embedded straight parts 21a. As described above, the metal bars 21 respectively have the bent parts where the metal bars 21 are bent or curved, and the bent parts are integrally formed with the first outer case 11.

The exposed straight parts 21d are straight-shaped (circular columnar-shaped) parts which are exposed from the first outer case body portion 15. The exposed straight parts 21d are connected to the embedded straight part 21a and extend in the Y axis direction. The exposed bent part 21e is a curve-shaped (arc-shaped) part exposed from the first outer case body portion 15, is connected to the exposed straight part 21d, and is curved toward the X axis direction from the Y axis direction. The exposed bent parts 21f are curve-shaped (arc-shaped) parts which are exposed from the first outer case body portion 15, and are connected to the exposed straight parts 21d and are curved toward a minus side in the Z axis direction from the X axis direction or from the Y axis direction.

The exposed end parts 21g are distal end portions of the metal bars 21 exposed from the first outer case body portion 15. The exposed end parts 21g are parts to be inserted into first connector 52 of the printed circuit board 50 described later, and extend downward (toward a minus side in the Z axis direction). With such a configuration, the metal bars 21 electrically connect the external conductive member and the printed circuit board 50 to each other. The insertion of the exposed end part 21g into the first connector 52 of the printed circuit board 50 is described in detail later.

Due to the above-mentioned configuration, the external connector 20 and the metal bar 21 are integrally formed with the first outer case 11. That is, the first outer case 11 is integrally formed together with the external connector 20 and the metal bar 21 by insert molding, for example. More specifically, by injecting a resin into a mold where the external connector 20 and the metal bar 21 are disposed, an integrally molded product constituting of the external connector 20, the metal bar 21, and the first outer case 11 is formed.

In FIG. 5, boundaries between a portion where the external connector 20 and the metal bar 21 are integrally formed with the first outer case 11 (by insert molding) and portions where the external connector 20 and the metal bars 21 are exposed from the first outer case 11 are indicated by a dotted line. That is, a portion of the external connector 20 on a plus side in the X axis direction with respect to the dotted line is integrally formed with the first outer case 11 (by insert molding), and a portion of the external connector 20 on a minus side in the X axis direction with respect to the dotted line is exposed from the first outer case 11. Further, portions of the metal bars 21 on a plus side in the Y axis direction with respect to the dotted line (that is, the portions ranging from the embedded straight parts 21a to the embedded bent parts 21b) are integrally formed with the first outer case 11 (by insert molding), and portion of the metal bars 21 on a minus side in the Y axis direction with respect to the dotted line (that is, the portions ranging from the exposed straight parts 21d to the exposed end parts 21g) are exposed from the first outer case 11.

As described above, it is preferable that the first outer case 11 be formed of a resin member made of a resin material which can be formed by insert molding. Although the resin member is made of one kind of resin material in this embodiment, the resin member may be made of a combination of a plurality of resin materials, a combination of a resin material and an elastomer material, or a material obtained by adding a particulate or fibrous inorganic material to a resin material.

Returning to FIG. 4A to FIG. 4C, the first outer case 11 further includes first positioning portions 16 which project downward (toward a minus side in the Z axis direction) from the first outer case body portion 15. The first positioning portions 16 are portions for positioning the first outer case 11 with respect to the holding member 40 by being engaged with the holding member 40. That is, the first positioning portions 16 are guide members which are disposed in a projecting manner toward the holding member 40, and guide the exposed end part 21g of the metal bar 21 to the first connector 52.

More specifically, the first positioning portions 16 are portions each having an L shape as viewed in a top plan view (plan view) which extend downward from the first outer case body portion 15. Further, four first positioning portions 16 are disposed on the periphery of the exposed end parts 21g so as to surround the exposed end parts 21g of the metal bar 21. The positioning of the first outer case 11 with respect to the holding member 40 by the first positioning portions 16 is described in detail later.

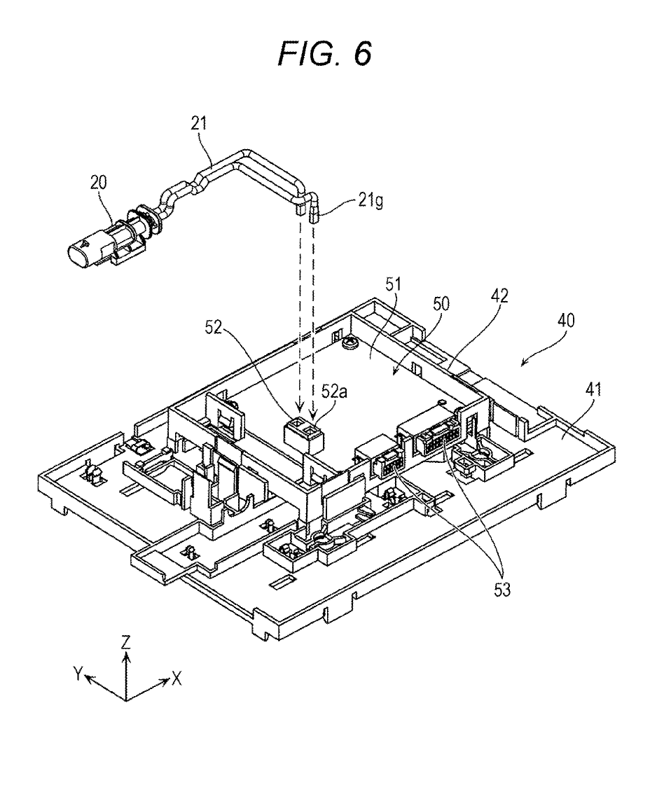

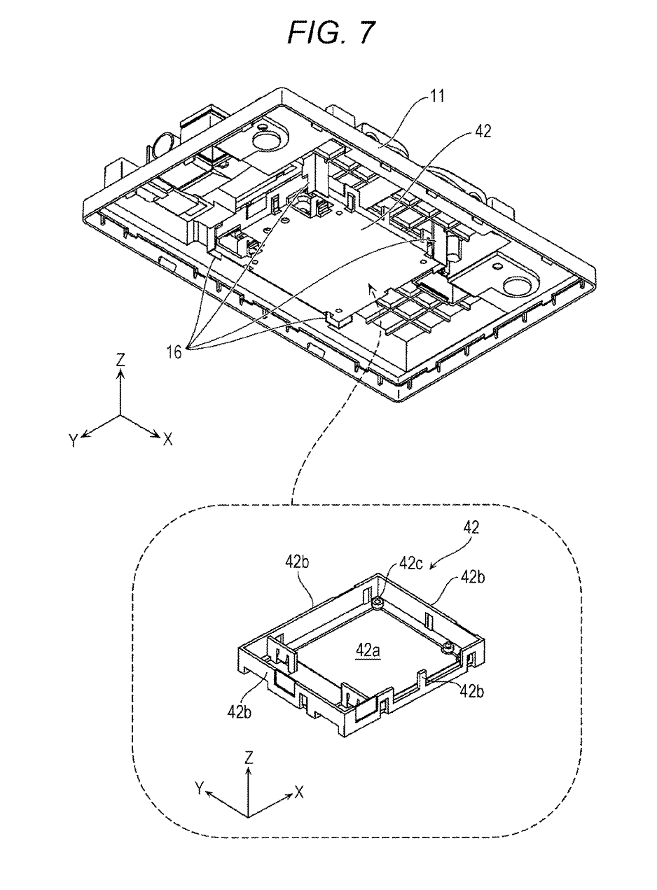

Next, the configuration of the holding member 40 and the printed circuit board 50, and the configuration where the first outer case 11 is positioned with respect to the holding member 40 and the exposed end parts 21g of the metal bar 21 are inserted into the first connector 52 of the printed circuit board 50 are described in detail. FIG. 6 is a perspective view showing the configuration of the holding member 40 and the printed circuit board 50 according to this embodiment, and the configuration where the exposed end parts 21g of the metal bar 21 are inserted into the first connector 52 of the printed circuit board 50. FIG. 7 is a perspective view showing a configuration of a second positioning portion 42 of the holding member 40 according to this embodiment, and a positional relationship between the first positioning portions 16 and the second positioning portion 42.

First, the configuration of the printed circuit board 50 is described in detail. As shown in FIG. 6, the printed circuit board 50 includes a printed circuit board body 51, the first connector 52, and second connectors 53. The printed circuit board body 51 is a flat plate-like rectangular mounting board on which electronic parts (not shown) are mounted, and four corners of the printed circuit board body 51 are fixed to the holding member 40 using screws. A method of fixing the printed circuit board body 51 to the holding member 40 is not limited to fixing by screws, and the printed circuit board body 51 may be fixed to the holding member 40 by any fixing method such as fixing by fitting or fixing by an adhesive agent.

The first connector 52 is a rectangular-shaped connector provided for communication between the printed circuit board 50 and the outside, and is mounted on an upper surface of the printed circuit board body 51 on a minus side in the X axis direction. For example, the first connector 52 is a connector for LIN communication for performing communication with a vehicle on which the energy storage apparatus 1 is mounted. More specifically, the first connector 52 is connected to an external conductive member (external wiring and the like for communication) through the connection of the first connector 52 with the metal bar 21 and hence, the external conductive member and the printed circuit board body 51 are connected to each other.

More specifically, the first connector 52 has two opening portions 52a which open upward, and two exposed end parts 21g of the metal bars 21 are inserted into two opening portions 52a. As described above, each metal bar 21 is configured such that the exposed end part 21g which forms an end part of a portion of the metal bar 21 exposed inward from the first outer case 11 is inserted into the first connector 52 of the printed circuit board 50. In this embodiment, the opening portion 52a has a shape (rectangular shape) which conforms to an outer shape of the exposed end part 21g. Accordingly, the metal bar 21 is engaged with the first connector 52 by fitting engagement in a state where the exposed end part 21g is inserted into the opening portion 52a of the first connector 52. However, the engagement between the metal bar 21 and the first connector 52 is not limited to the fitting engagement, and the metal bar 21 is engaged with the first connector 52 such that the exposed end part 21g is inserted into the opening portion 52a and is merely brought into contact with the first connector 52 in the inside of the first connector 52.

The first connector 52 is configured such that a portion of the first connector 52 into which the metal bar 21 is fitted is formed movably relative to the printed circuit board 50 along the surface of the printed circuit board 50. That is, the first connector 52 is configured such that a portion of the first connector 52 having the opening portions 52a into which the metal bars 21 are fitted is formed movably on the printed circuit board body 51 along an XY plane. More specifically, the first connector 52 is a movable connector where the opening portions 52a are movable in a front-back direction as well as in a leftward and rightward direction (toward both sides in the X axis direction and toward both sides in the Y axis direction) by an approximately 0.5 mm.

The second connectors 53 are rectangular-shaped connectors for acquiring states of the plurality of energy storage devices 100 in the energy storage unit 30, and are mounted on an upper surface of the printed circuit board body 51 on a minus side in the Y axis direction. More specifically, the second connectors 53 are connected to the plurality of energy storage devices 100 in the energy storage unit 30 by wirings or the like so as to connect the plurality of energy storage devices 100 and the printed circuit board body 51 to each other.

Next, the configuration of the holding member 40 is described in detail. The holding member 40 includes a flat rectangular-shaped holding member body portion 41 which forms a body portion of the holding member 40, and the second positioning portion 42.

The second positioning portion 42 is a portion which is engaged with the first outer case 11 and positions the first outer case 11 with respect to the holding member 40. More specifically, the second positioning portion 42 is a guide member which is disposed on the holding member 40 in a projecting manner toward the first outer case 11, and is engaged with the first positioning portions 16 of the first outer case 11 and guides the exposed end parts 21g of the metal bars 21 to the opening portions 52a of the first connector 52.

More specifically, as shown in FIG. 7, the second positioning portion 42 has a bottom wall portion 42a, a side wall portion 42b, and fixing portions 42c. The bottom wall portion 42a is a flat plate-like rectangular-shaped portion disposed on a lower portion (bottom portion) of the second positioning portion 42, and covers the printed circuit board body 51 from below. The side wall portion 42b is a flat plate-like rectangular-shaped portion which is raised upward from four sides constituting an outer edge of the bottom wall portion 42a, and positions the printed circuit board body 51 by being disposed so as to surround the periphery of the printed circuit board body 51. The fixing portions 42c are portions which are disposed at four corners of the second positioning portion 42 and in each of which a threaded hole is formed, and are provided for fixing four corners of the printed circuit board body 51 using screws or the like.

In such a configuration, the side wall portion 42b is disposed such that the side wall portion 42b is sandwiched between four first positioning portions 16 so as to be surrounded by four first positioning portions 16 of the first outer case 11. More specifically, the side wall portion 42b is configured such that four corners of the side wall portion 42b are brought into contact (engaged) with four first positioning portions 16. With such a configuration, the side wall portion 42b of the second positioning portion 42 is engaged with the first positioning portions 16 of the first outer case 11 and hence, the second positioning portion 42 can guide the exposed end parts 21g of the metal bar 21 to the opening portions 52a of the first connector 52.

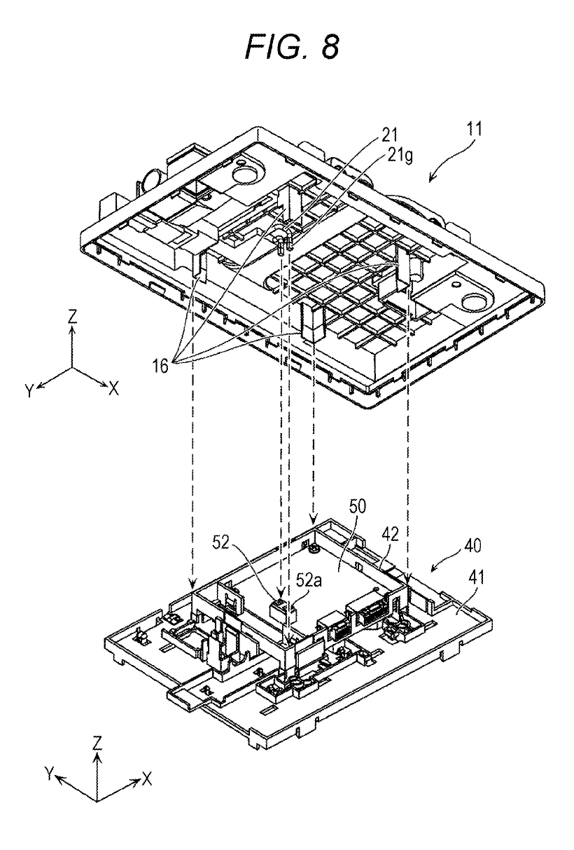

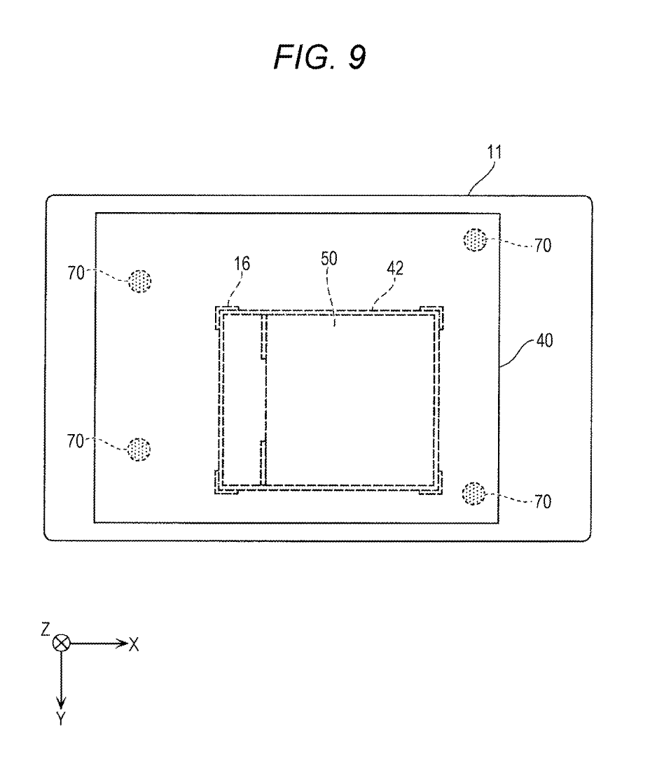

Hereinafter, the description is made in detail with respect to the configuration where the first outer case 11 is positioned with respect to the holding member 40 so that the exposed end parts 21g of the metal bars 21 are inserted into the first connector 52. FIG. 8 is a perspective view showing the configuration where the first outer case 11 is positioned with respect to the holding member 40 according to this embodiment, and the exposed end parts 21g of the metal bars 21 are inserted into the first connector 52 of the printed circuit board 50. FIG. 9 is a plan view showing a configuration where the first outer case 11 and the holding member 40 according to this embodiment are joined to each other.

Firstly, as shown in FIG. 8, in a manufacturing process of the energy storage apparatus 1, by performing positioning of the first outer case 11 with respect to the printed circuit board 50 as viewed in a direction (Z axis direction) toward the printed circuit board 50 from the first outer case 11, the exposed end parts 21g of the metal bars 21 are made to overlap with the first connector 52 (positioning step).

More specifically, as described previously, by making the first positioning portions 16 of the first outer case 11 and the second positioning portion 42 of the holding member 40 engage with each other, positioning of the first outer case 11 with respect to the holding member 40 is performed. That is, when the first positioning portions 16 of the first outer case 11 and the second positioning portion 42 of the holding member 40 are engaged with each other, the exposed end parts 21g of the metal bars 21 and the opening portions 52a of the first connector 52 are disposed at substantially the same positions as viewed in the Z axis direction. Accordingly, end parts (exposed end parts 21g) of portions of the metal bars 21 integrally formed with the first outer case 11 which are exposed inward from the first outer case 11 can be made to overlap with the first connector 52 of the printed circuit board 50 as viewed in the Z axis direction.

Then, the exposed end parts 21g of the metal bars 21 are inserted into the first connector 52 (insertion step). More specifically, by bringing the first outer case 11 close to the holding member 40 in a state where the first positioning portions 16 and the second positioning portion 42 are engaged with each other, the exposed end parts 21g are inserted into the opening portions 52a of the first connector 52.

That is, each metal bar 21 is a metal-made rod-like member and hence, the metal bar 21 has a certain degree of hardness. Accordingly, by bringing the first outer case 11 close to the holding member 40, the exposed end parts 21g of the metal bars 21 are inserted into the opening portions 52a of the first connector 52 without being bent. In such an operation, the first connector 52 is a movable connector and hence, when the positions of the exposed end parts 21g of the metal bars 21 and the positions of the opening portions 52a of the first connector 52 are not completely aligned with each other, the opening portions 52a are moved so that the exposed end parts 21g are inserted into the opening portions 52a.

As shown in FIG. 9, the first outer case 11 and the holding member 40 are joined to each other (joining step). That is, after the first outer case 11 is positioned with respect to the holding member 40, the first outer case 11 and the holding member 40 are joined to each other by heat sealing or by an adhesive agent or the like at four corners of the holding member 40. With such an operation, the first outer case 11 and the holding member 40 are joined to each other thus forming joint portions 70.

The joint portions 70 are portions formed by joining the first outer case body portion 15 of the first outer case 11 and the holding member body portion 41 of the holding member 40 to each other, and are disposed around the first positioning portions 16 of the first outer case 11 and the second positioning portion 42 of the holding member 40. In this embodiment, although the joint portions 70 are disposed on the four corners of the holding member 40, the positions of the joint portion 70 are not limited to the four corners of the holding member 40. The joint portion 70 may be disposed around the first positioning portions 16 in a dotted manner or may be disposed in a surrounding wall shape so as to surround the first positioning portions 16.

As has been described heretofore, the energy storage apparatus 1 according to this embodiment includes the metal bars 21 for connecting the external conductive member and the printed circuit board 50 to each other, the metal bars 21 are integrally formed with the first outer case 11, and the exposed end parts 21g are inserted into the first connector 52 of the printed circuit board 50. That is, the energy storage apparatus 1 is configured such that by inserting the metal bars 21 integrally formed with the first outer case 11 into the first connector 52, the metal bars 21 can be easily inserted into the first connector 52.

Conventionally, a member corresponding to the metal bar 21 is a cable (electric wire). Accordingly, in the manufacture of an energy storage apparatus, firstly, one end of the cable is connected to a printed circuit board (corresponding to the printed circuit board 50) disposed on a body (corresponding to the second outer case 12) side of an outer case, and the other end of the cable is connected to an external connector (corresponding to the external connector 20). The connection between one end of the cable and the printed circuit board can be performed by connecting one end of the cable to the printed circuit board by forming one end of the cable as a connector or by soldering one end of the cable to the printed circuit board. Then, the external connector is inserted into an opening portion of a lid body (corresponding to the first outer case 11) of the outer case thus positioning the external connector with respect to the lid body, and the external connector is fixed to the lid body. Then, the lid body and the body of the outer case are joined to each other so that an opening portion of the lid body is sealed.

In this manner, conventionally, the configuration for connecting a printed circuit board to the external conductive member using the cable is complicated, and an assembling operation of the configuration is also complicated. Particularly, before the external connector is fixed to the lid body, the external connector is in a freely movable state and hence, the configuration and the operation for inserting the freely movable external connector into the opening portion of the lid body or for disposing the freely movable external connector at a normal position of the lid body are complicated.

According to the energy storage apparatus 1 of this embodiment, the conventional configuration for connecting the cable and the printed circuit board to each other can be simplified. The metal bars 21 are integrally formed with the first outer case 11 by insert molding and hence, airtightness between the metal bars 21 and the first outer case 11 can be also ensured with the simple configuration.

The metal bars 21 have the bent parts such as the exposed bent parts 21e, 21f and hence, the adjustment of positions where the metal bars 21 are inserted into the first connector 52 can be easily performed whereby the metal bars 21 can be easily inserted into the first connector 52.

The bent parts such as the embedded bent parts 21b, 21c of the metal bars 21 are integrally formed with the first outer case 11 and hence, the metal bars 21 can be stably fixed in the first outer case 11 whereby the metal bars 21 can be stably disposed.

The portions of the first connector 52 into which the metal bars 21 are fitted move along the surface of the printed circuit board 50 and hence, the metal bars 21 can be easily fitted into the first connector 52. Accordingly, the metal bars 21 can be easily inserted into the first connector 52.

The first positioning portions 16 and the second positioning portion 42 position the first outer case 11 with respect to the holding member 40 of the printed circuit board 50 and hence, the metal bars 21 integrally formed with the first outer case 11 can be easily positioned with respect to the first connector 52 of the printed circuit board 50. Accordingly, the metal bars 21 can be easily inserted into the first connector 52.

The first positioning portions 16 projecting toward the holding member 40 of the first outer case 11 guide the exposed end parts 21g of the metal bars 21 to the first connector 52 and hence, the metal bars 21 can be easily inserted into the first connector 52.

The first outer case 11 and the holding member 40 are joined to each other and hence, it is possible to suppress the displacement of the metal bars 21 from the first connector 52.

The first outer case 11 and the holding member 40 are joined to each other around the first positioning portions 16 and the second positioning portion 42 and hence, a firm joint between the first outer case 11 and the holding member 40 can be achieved whereby it is possible to more effectively suppress the displacement of the metal bars 21 from the first connector 52.

The metal bar 21 is formed of a flexible member having rigidity and flexibility and hence, even when vibration or impact is generated on the metal bar 21, it is possible to suppress breaking of the metal bar 21 between the embedded straight part 21a and the exposed straight part 21d, for example.

According to the method of manufacturing the energy storage apparatus 1 of this embodiment, the exposed end parts 21g of the metal bars 21 integrally formed with the first outer case 11 are made to overlap with the first connector 52 of the printed circuit board 50 as viewed in a direction from the first outer case 11 toward the printed circuit board 50, and the exposed end parts 21g are inserted into the first connector 52. That is, in the method of manufacturing the energy storage apparatus 1, by inserting the metal bars 21 integrally formed with the first outer case 11 into the first connector 52, the metal bars 21 can be easily inserted into the first connector 52. Therefore, according to the method of manufacturing the energy storage apparatus 1, the conventional connection configuration between the cable and the printed circuit board can be simplified. The metal bars 21 are integrally formed with the first outer case 11 by insert molding or the like and hence, airtightness between the metal bars 21 and the first outer case 11 can be ensured with the simple configuration.

The exposed end parts 21g of the metal bars 21 can be made to overlap with the first connector 52 by positioning the first outer case 11 with respect to the printed circuit board 50. That is, the metal bars 21 can be inserted into the first connector 52 by positioning the first outer case 11 with respect to the printed circuit board 50 and, thereafter, by bringing the first outer case 11 close to the printed circuit board 50. In this manner, the metal bars 21 can be easily inserted into the first connector 52.

### (Modification 1)

Next, a modification 1 of the above-mentioned embodiment is described. In the above-mentioned embodiment, the metal bar 21 has a shape extending straightly downward toward the exposed end part 21g from the exposed bent part 21f while having substantially the same diameter. However, in this modification, a metal bar has a plurality of bent parts in a middle of the metal bar extending toward an exposed end part from an exposed bent part 21f, and has a shape where the exposed end part is tapered toward a distal end.

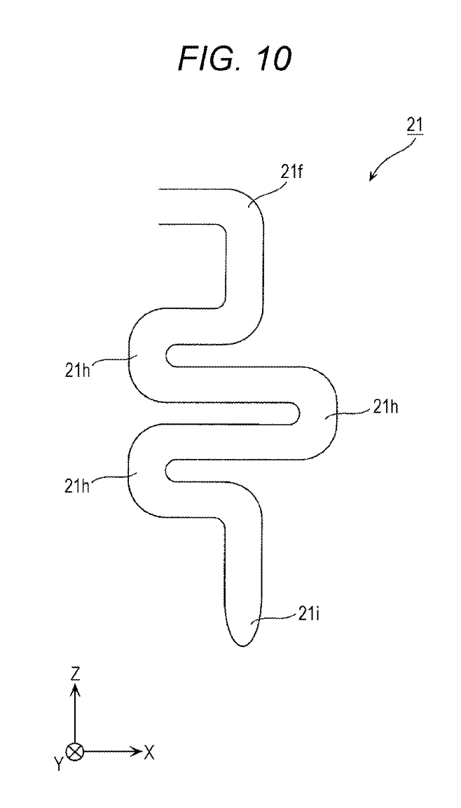

FIG. 10 is a side view showing a configuration of a metal bar 21 according to the modification 1 of the embodiment of the present invention. More specifically, FIG. 10 shows a portion of the metal bar 21 disposed on a distal end side with respect to an exposed bent part 21f. A configuration of the metal bar 21 according to this modification disposed on an external connector 20 side with respect to the exposed bent part 21f, and other constitutional elements are substantially equal to the corresponding configurations and constitutional elements in the above-mentioned embodiment and hence, their detailed description is omitted.

As shown in the drawing, the metal bar 21 according to this modification has a plurality of exposed bent parts 21h in a middle of a portion of the metal bar 21 ranging from the exposed bent part 21f to an exposed end part 21i. The exposed bent parts 21h are curve-shaped (approximately semicircular-shaped) parts exposed from a first outer case 11, and are curved toward a minus side or a plus side in the X axis direction from a plus side or a minus side in the X axis direction. In this manner, the metal bar 21 has the plurality of bent parts in the middle of the portion extending toward a first connector 52 (toward a minus side in the Z axis direction).

The exposed end part 21i has a shape tapered toward a distal end (a minus side in the Z axis direction). That is, the metal bar 21 has a shape where the exposed end part 21i is tapered toward the first connector 52. In the drawing, the exposed end part 21i is formed such that an outer edge shape of the distal end portion in cross section including a center axis of the exposed end part 21i is formed into a downwardly projecting semielliptical shape. However, the outer edge shape is not particularly limited. The outer edge may be formed into any shape such as a downwardly projecting semicircular shape, a triangular shape, a trapezoidal shape, or a stepped shape, provided that the exposed end part 21i is easily inserted into an opening portion 52a of the first connector 52.

As has been described above, the energy storage apparatus 1 according to this modification can also acquire substantially the same advantageous effects as the above-mentioned embodiment. Particularly, the plurality of bent parts are formed on the portion of the metal bar 21 extending toward the first connector 52 and hence, a movable range of the exposed end part 21i of the metal bar 21 is expanded. Accordingly, the adjustment of the position where the metal bar 21 is inserted into the first connector 52 can be performed more easily and hence, the metal bar 21 can be more easily inserted into the first connector 52.

The exposed end part 21i of the metal bar 21 is tapered and hence, the metal bar 21 can be easily inserted into the first connector 52.

The exposed bent part 21h may be disposed closer to an external connector 20 side than the exposed bent part 21f of the metal bar 21.

### (Modification 2)

Next, a modification 2 of the above-mentioned embodiment is described. In the above-mentioned embodiment, the metal bars 21 are integrally formed with the first outer case 11 by insert molding. However, in this modification, a metal bar is integrally formed with a first outer case fixedly by adhesion or by fastening.

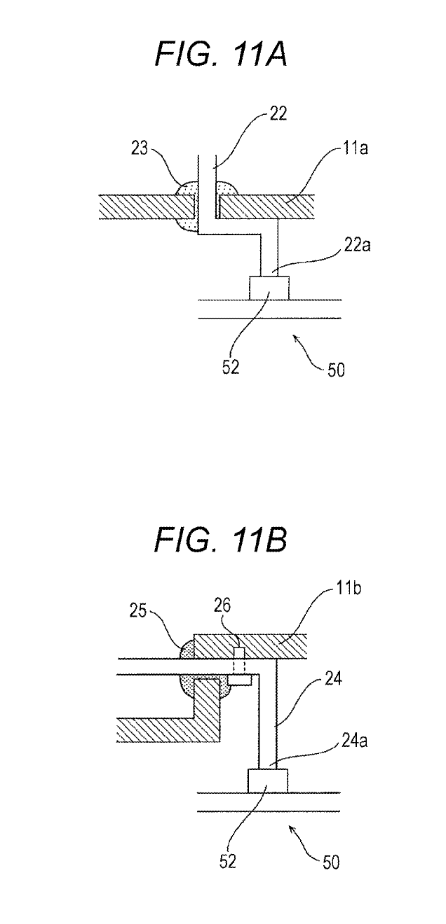

FIG. 11A and FIG. 11B are views showing configurations where a metal bar according to the modification 2 of the embodiment and a first outer case are integrally formed with each other. More specifically, FIG. 11A is a cross-sectional view showing a configuration where a metal bar 22 is integrally formed with a first outer case 11a fixedly by adhesion. FIG. 11B is a cross-sectional view showing a configuration where a metal bar 24 is integrally formed with a first outer case 11b fixedly by fastening.

These drawings show the configurations where the metal bar and the first outer case are integrally formed with each other in a simplified manner. Accordingly, sizes and the like of the constitutional elements do not agree with those shown in other drawings. Further, constitutional elements other than the constitutional elements shown in the drawings are substantially equal to the corresponding constitutional elements of the above-mentioned embodiment and hence, their detailed description is omitted.

Firstly, as shown in FIG. 11A, the metal bar 22 is inserted into a through hole formed in the first outer case 11a, the through hole is sealed by an adhesive agent 23 and, at the same time, the metal bar 22 is fixed by adhesion to the first outer case 11a so that the metal bar 22 is integrally formed with the first outer case 11a. An exposed end part 22a of the metal bar 22 is connected to the first connector 52 by being inserted into the first connector 52 of the printed circuit board 50. A material of the adhesive agent 23 is not particularly limited, and a conventional adhesive agent can be suitably used.

As shown in FIG. 11B, the metal bar 24 is inserted into a through hole formed in the first outer case 11b, the through hole is sealed by an adhesive agent 25 and, at the same time, the metal bar 24 is fixed by fastening to the first outer case 11b using a screw 26 thus being integrally formed with the first outer case 11b. In the metal bar 24, a through hole into which the screw 26 is inserted is formed, and a threaded hole with which the screw 26 is threadedly engaged is formed in the first outer case 11b. An exposed end part 24a of the metal bar 24 is connected to a first connector 52 of a printed circuit board 50 by being inserted into the first connector 52. A material for forming the adhesive agent 25 and a material for forming the screw 26 are not particularly limited, and a conventional sealing material and a conventional screw can be suitably used.

As has been described above, the energy storage apparatus 1 according to this modification can also acquire substantially the same advantageous effect as the above-mentioned embodiment. Particularly, according to this modification, the metal bar and the first outer case can be integrally formed with each other by various methods and hence, the degree of freedom in integrally forming the metal base and the first outer case with each other can be increased.

Although the energy storage apparatus 1 according to the embodiment of the present invention and the modifications of the embodiment have been described heretofore, the present invention is not limited to the above-mentioned embodiment and the modifications of the embodiment. That is, it should be construed that the embodiment and the modifications of the embodiment disclosed in this specification are only for an exemplifying purpose in all aspects and are not limited. The scope of the present invention is not designated by the above-mentioned description but is designated by Claims, and it is intended that all modifications which fall within the meaning and the scope equivalent to Claims are also included in the scope of the present invention.

For example, in the above-mentioned embodiment and the modifications of the embodiment, the metal bar 21 (the metal bar, 22, 24 in the modification 2, the same definition being applied to the description made hereinafter) has a circular shape or a rectangular shape in cross section. However, the cross-sectional shape of the metal bar 21 is not particularly limited, and may be any shape such as an elliptical shape, an elongated circular shape, a triangular shape, or other polygonal shapes. That is, the metal bar 21 is not limited to a shape where a linear-shaped member extends, and may be a shape where a plate-like member extends, for example.

In the above-mentioned embodiment and the modifications of the embodiment, the bent part of the metal bar 21 has a curved shape or a bent shape. However, the bent part of the metal bar 21 may have a hinge shape. Alternatively, the metal bar 21 may be formed of a straight member as a whole, having no bent part.

In the above-mentioned embodiment and the modifications of the embodiment, the metal bar 21 is configured such that all of the embedded straight parts 21a and the embedded bent parts 21b, 21c are integrally formed with the first outer case 11 (the first outer case 11a, 11b in the modification 2, the same definition also applied to the description made hereinafter). However, the metal bar 21 may be configured such that the embedded straight parts 21a and the embedded bent parts 21b, 21c are partially exposed from the first outer case 11. That is, it is sufficient that the metal bar 21 is configured such that at least a portion of the embedded straight parts 21a and the embedded bent parts 21b, 21c is integrally formed with the first outer case 11.

In the above-mentioned embodiment and the modifications of the embodiment, the metal bar 21 is configured such that all of the exposed straight part 21d and the exposed bent parts 21e, 21f are exposed from the first outer case 11. However, the metal bar 21 may be configured such that the exposed straight part 21d and the exposed bent parts 21e, 21f are partially integrally formed with the first outer case 11.

In the above-mentioned embodiment and the modifications of the embodiment, the exposed end part 21g which is inserted into the first connector 52 of the printed circuit board 50 is disposed on the distal end portion of the metal bar 21. However, the exposed end part 21g may be disposed not on the distal end portion of the metal bar 21 but on a middle of the metal bar 21 and be inserted into the first connector 52.

In the above-mentioned embodiment and the modifications of the embodiment, the external connector 20 and the metal bar 21 are integrally formed with the first outer case 11. However, the external connector 20 may not be integrally formed with the first outer case 11, and may be formed as a member separate from the first outer case 11. Alternatively, the energy storage apparatus 1 may be configured such that the energy storage apparatus 1 does not have the external connector 20, and a portion of the first outer case 11 has a shape of the external connector 20.

In the above-mentioned embodiment and the modifications of the embodiment, the first connector 52 is the movable connector. However, the first connector 52 may not be a movable connector, and may be fixed to the printed circuit board body 51.

In the above-mentioned embodiment and the modifications of the embodiment, the first outer case 11 includes the first positioning portions 16, and the holding member 40 includes the second positioning portion 42. However, it is unnecessary that both the first outer case 11 and the holding member 40 include the positioning portion respectively for the positioning between the first outer case 11 and the holding member 40. It is sufficient that either one of the first outer case 11 or the holding member 40 has a positioning portion, and positioning is performed by bringing the positioning portion of one of the first outer case 11 and the holding member 40 into contact with an existing portion of the other of the first outer case 11 and the holding member 40. Alternatively, neither the first outer case 11 nor the holding member 40 may include the positioning portion.

In the above-mentioned embodiment and the modifications of the embodiment, the first outer case 11 and the holding member 40 are joined to each other around the first positioning portions 16 and the second positioning portion 42. However, a joining portion of the first outer case 11 and the holding member 40 may not be disposed around the positioning portions. That is, such a joining portion may be disposed inside the positioning portions or a place away from the positioning portions or the like. Alternatively, the first outer case 11 and the holding member 40 may not be joined to each other.

Further, the configurations which are formed by arbitrarily combining the respective constitutional elements which the above-mentioned embodiment and the modifications of the embodiment include are also included in the scope of the present invention.

The present invention can be realized not only in the form of the energy storage apparatus 1 but also in the form of the first outer case 11, the metal bar 21, the first connector 52 or the holding member 40 which the energy storage apparatus 1 includes.

### INDUSTRIAL APPLICABILITY

The present invention is applicable to an energy storage apparatus including an energy storage device such as a lithium ion secondary battery or the like.

What is claimed is:

1. An energy storage apparatus comprising:
an energy storage device;
a circuit board;
an outer case; and
a metal bar which electrically connects an external conductive member and the circuit board to each other, wherein
the metal bar is integrally formed with the outer case, and an end part of a portion of the metal bar which is exposed inward from the outer case is inserted into a connector of the circuit board.

2. The energy storage apparatus according to claim 1, wherein the metal bar has a bent part which is bent or curved.

3. The energy storage apparatus according to claim 2, wherein at least a portion of the bent part is integrally formed with the outer case.

4. The energy storage apparatus according to claim 2, wherein the metal bar has a plurality of the bent parts in a middle of a portion of the metal bar extending toward the connector.

5. The energy storage apparatus according to claim 1, wherein a portion of the connector into which the metal bar is fitted is formed movably relative to the circuit board along a surface of the circuit board.

6. The energy storage apparatus according to claim 1, wherein the energy storage apparatus further includes a holding member for holding the circuit board, and
at least one of the outer case and the holding member has a positioning portion which engages with the other of the outer case and the holding member and positions the outer case with respect to the holding member.

7. The energy storage apparatus according to claim 6, wherein the outer case includes the positioning portion which is formed on the outer case in a projecting manner toward the holding member, and guides the end part of the metal bar to the connector.

8. The energy storage apparatus according to claim 6, wherein the outer case and the holding member have a joint portion formed by joining the outer case and the holding member to each other.

9. The energy storage apparatus according to claim 8, wherein the joint portion is disposed around the positioning portion.

10. The energy storage apparatus according to claim 1, wherein the metal bar is formed into a shape where the end part of the metal bar is tapered toward the connector.

11. A method of manufacturing an energy storage apparatus including an energy storage device, a circuit board, and an outer case, the method comprising:
a positioning step where an end part of a portion of a metal bar integrally formed with the outer case exposed inward from the outer case is made to overlap with a connector of the circuit board as viewed in a direction from the outer case toward the circuit board; and
an insertion step where the end part is inserted into the connector.

12. The method of manufacturing an energy storage apparatus according to claim 11, wherein in the positioning step, the end part of the metal bar is made to overlap with the connector by positioning the outer case with respect to the circuit board.
